(19) United States
(12) Patent Application Publication
(10) Pub. No.: US 2006/0231619 A1
(43) Pub. Date: Oct. 19, 2006

(54) ELECTRONIC DEVICE CAPABLE OF EJECTING A CARD WHEN A COVER IS OPENED

(76) Inventor: Wei-Lung Lee, Taipei City (TW)

Correspondence Address: NORTH AMERICA INTELLECTUAL PROPERTY CORPORATION, P.O. BOX 506, MERRIFIELD, VA, 22116, US

(21) Appl. No.: 11/279,560

(22) Filed: Apr. 12, 2006

(30) Foreign Application Priority Data
Apr. 19, 2005 (TW) 094112421

(51) Int. Cl. G06K 7/06

(52) U.S. Cl. 235/441

(57) ABSTRACT

An electronic device includes a body having a cavity for accommodating a card, a flexible element positioned at an end of the cavity, and a cover connected to the electronic device in a rotatable manner. The cover includes a panel having an opening, and an activating element. The activating element has a protrusion. When an end of the activating element is pressed, the protrusion pushes the card to press the flexible element so that the card can be ejected out of the cavity.

### BACKGROUND OF THE INVENTION

1. Field of the Invention

The present invention relates to an electronic device, and more particularly, to an electronic device capable of ejecting a memory card when a cover is opened.

2. Description of the Prior Art

Portable electronic devices, such as mobile phones, personal data assistants (PDAs), hand-held computers, and notebook computers, allow users to communicate with each other and access data anytime and anywhere.

Take a mobile phone for example. In addition to wireless communication, a mobile phone can also provide functions like video recording, taking digital pictures, and playing music from MP3 files. Such a mobile phone requires considerable memory capacity so as to provide more functions. Generally, how to increase the memory capacity of the mobile phone is to embed a memory card in the mobile phone or externally insert a memory card into the mobile phone.

For externally inserting the memory card into the mobile phone, there should be a memory card slot in the mobile phone. If the space of the memory card slot in the mobile phone only accommodates the connection interface of the memory card, that is, most of the memory card is outside the mobile phone, it is easy for the memory card to become loose and detach from the mobile phone. Besides, the external memory card and the entire structure of the mobile phone are inelegant.

If the space of the memory card slot is large enough to accommodate the entire memory card, in other words, the memory card is entirely inside the mobile phone, the memory card is well protected. In this case, there is a cover made of rubber connected to the housing of the mobile phone to prevent the memory card from being ejected out of the mobile phone. However, due to the narrow width of the memory card slot, it is difficult and inconvenient for the user to take the memory card out of the mobile phone. Additionally, the rubber cover can become deformed after being used frequently.

### SUMMARY OF THE INVENTION

It is therefore a primary objective of the claimed invention to provide an electronic device capable of ejecting a memory card when a cover is opened to solve the above-mentioned problem.

The electronic device of the claimed invention comprises a body, and a cover rotatably connected to the body via a first end of the cover. The body comprises a cavity for accommodating a card, and a first flexible element positioned at an end of the cavity for pushing the card. The cover comprises a panel having an opening, and an activating element rotatably positioned inside the opening.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of an electronic device of the present invention.

FIG. 2 is a diagram of the panel of the cover of the electronic device of FIG. 1.

FIG. 3 is a diagram of the activating element of the cover of the electronic device of FIG. 1.

FIG. 4 is a diagram of an assembly of the panel and the activating element of FIG. 1.

FIG. 5 to FIG. 7 shows how a memory card is ejected from the cavity.

FIG. 8 shows the positions of the second flexible element and the slot in the body of the electronic device of FIG. 1.

FIGS. 9 and 10 are diagrams of opening the cover of the electronic device of FIG. 1.

FIGS. 11 and 12 are diagrams showing taking the memory card out of the electronic device of FIG. 1.

FIG. 13 shows the panel of FIG. 1 assembled with another embodiment of the activating element.

### DETAILED DESCRIPTION

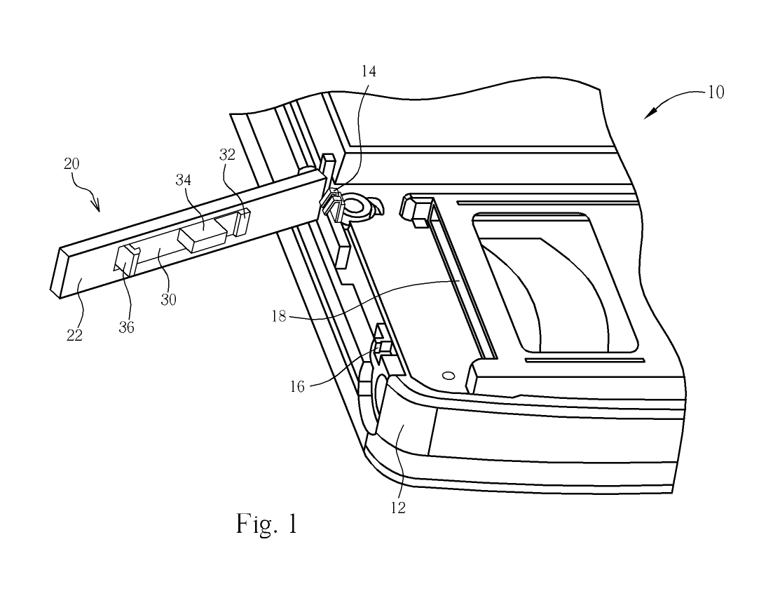

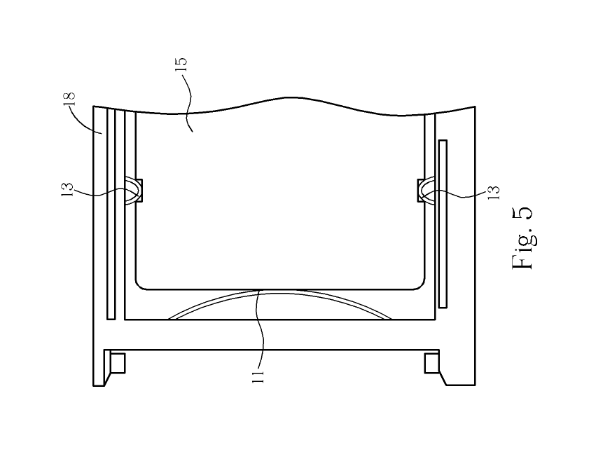

Please refer to FIG. 1, which is a diagram of an electronic device 10 of the present invention. The electronic device 10 comprises a body 12 and a cover 20 rotatably connected to the body 12 via a first end of the cover 20. The body 12 comprises a cavity 18 for accommodating a memory card. There is a first flexible element (see FIG. 5) positioned on the inner side of the cavity 18 for pushing the memory card. Another flexible element (second flexible element) 14 and a slot 16 are positioned on the body 12. The cover 20 comprises a panel 22 and an activating element 30. The activating element 30 comprises a hook 36, a protrusion 34, and a stopper 32.

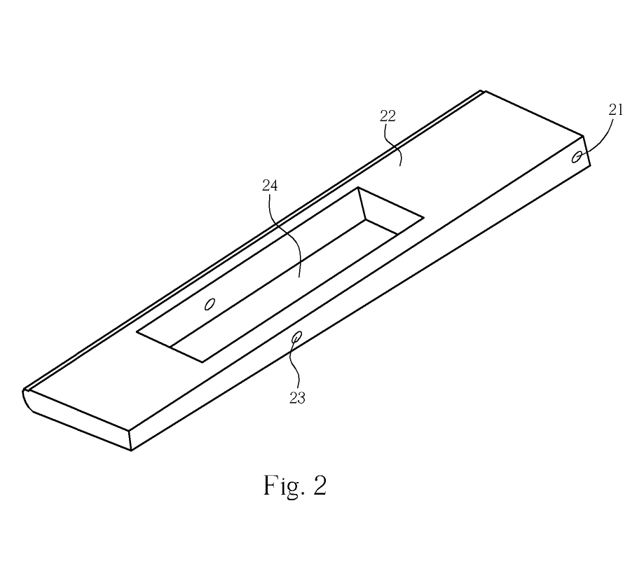

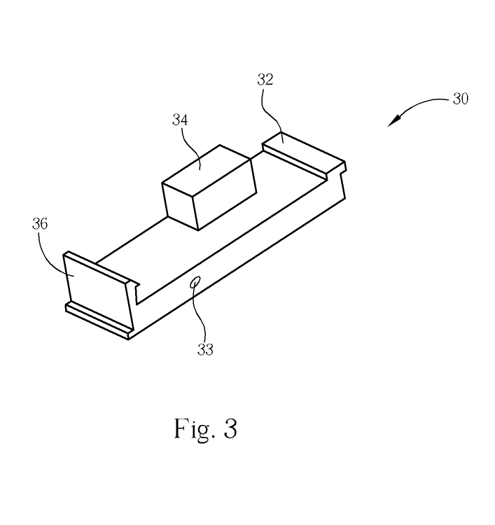

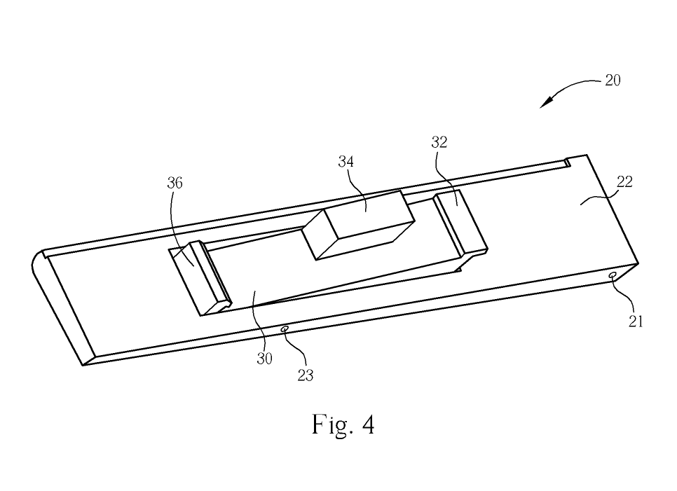

In the first place, the details of the cover 20 are disclosed as follows. Please refer to FIG. 2, which is a diagram of the panel 22. The panel 22 comprises an opening 24 for accommodating the activating element 30. A first end of the panel 22 includes a hole 21 for accommodating a revolving spindle. The panel 22 is rotatably connected to the body 12 via the revolving spindle. There is a hole 23 on each long side of the opening 24 to position the activating element 30 in the opening 24. Please refer to FIG. 3, which is a diagram of the activating element 30. The activating element 30 includes a hole 33 corresponding to the holes 23 of the opening 24 for accommodating the revolving spindle. Please refer to FIG. 4, which is a diagram of an assembly of the panel 22 of FIG. 2 and the activating element 30 of FIG. 3. The stopper 32 of the activating element 30 is not inside the range of the opening 24. Therefore, when a first end (the end of the hook 36) of the activating element 30 is pressed and after the hook 36 engages the slot 16 on the body 12, the stopper 32 presses against the panel 22 so as to prevent the activating element 30 from rotating further.

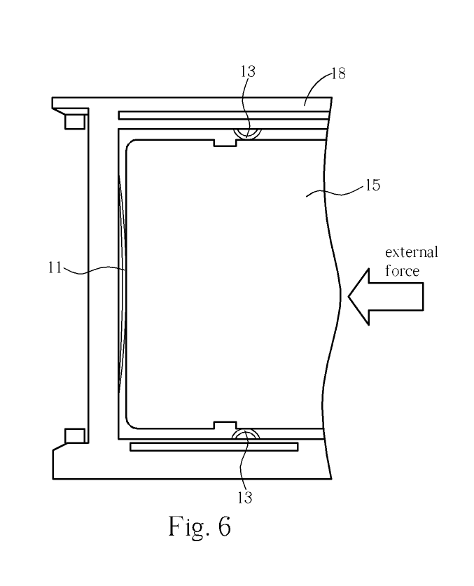

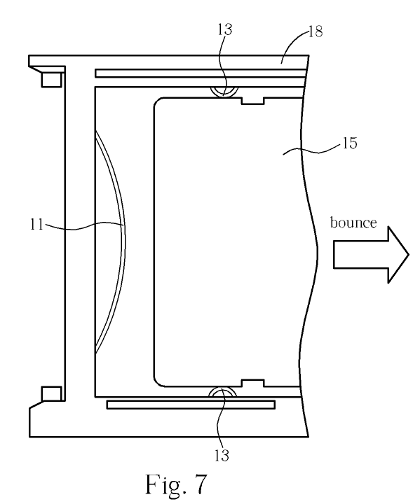

Generally, the design of memory card slots for Secure Digital (SD) cards, Compact Flash (CF) cards, Multimedia cards (MCC), or other cards, includes the first flexible element positioned on the inner side of the cavity 18 for pushing the memory card out of the cavity 18. Please refer to FIG. 5, which is a perspective diagram of the cavity 18 accommodating a memory card 15. In this embodiment, the first flexible element comprises flexible pieces 11 and 13. The memory card 15 of FIG. 5 is held stable by the flexible piece 13 on each side. To take out the memory card 15, an external force is provided to the outer side of the memory card 15 to compress the flexible piece 11. When the flexible piece 11 becomes compressed completely, the flexible pieces 13 are no longer in the recesses of the memory card 15, as shown in FIG. 6. Finally, the reaction (i.e. bounce) of the flexible piece 11 ejects the memory card 15, as shown in FIG. 7. The flexible piece 11 becomes completely uncompressed while the memory card 15 is ejected. The first flexible element is not limited as the above, and can be accomplished by a spring and locking members.

Therefore, with the design of the first flexible element, when a second end of the activating element 30 (the end of the stopper 32) is pressed, the protrusion 34 pushes the memory card 15 to press the flexible piece 11, so that the memory card 15 is ejected out of the cavity 18 because of the bounce effect of the flexible piece 11. Additionally, when the second end of the activating element 30 is pressed, the activating element 30 rotates clockwise so that the hook 36 separates from the slot 16. That is, the cover 20 is unlocked. After the cover is pushed outward, the memory card 15 can be ejected. The user just pushes the cover 20 once to take out the memory card 150 easily.

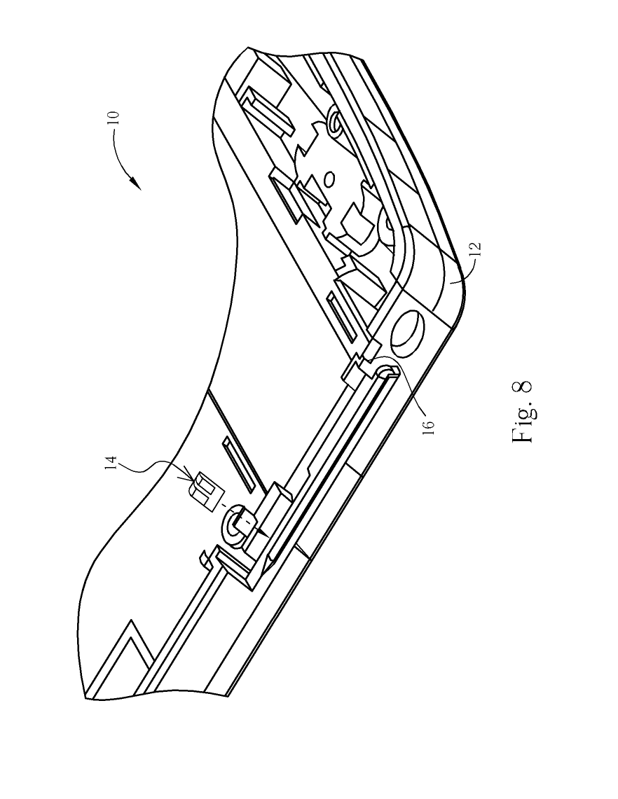

Please refer to FIG. 8, which is a diagram of the positions of the second flexible element 14 and the slot 16. The second flexible element 14 is positioned near the place where the first end of the cover 20 is connected to the body 12. As mentioned above, the memory card 15 pushes the cover 20 outward. In order to ensure that the force imposed on the cover 20 is enough to push the cover 20 outward, the present invention further comprises the second flexible element 14 to provide bounce to the cover 20. This ensures that the second end of the cover 20 departs from the body 12 when the cover 20 is unlocked.

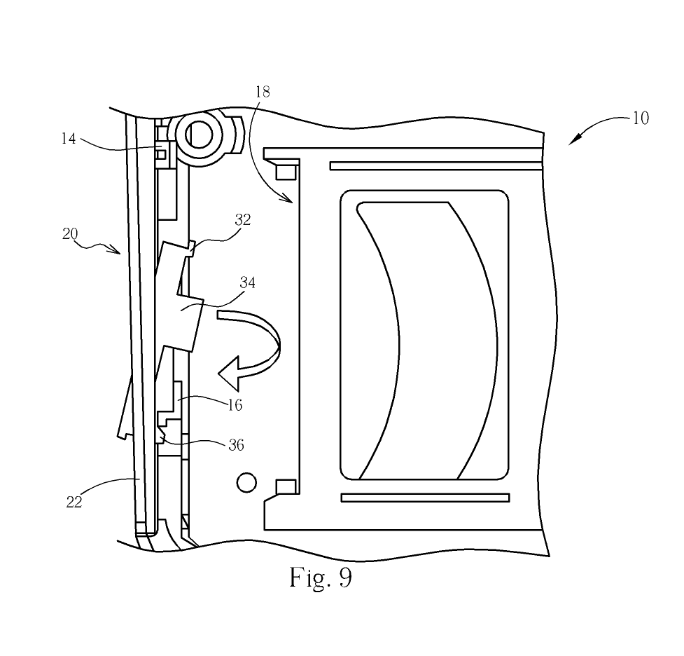

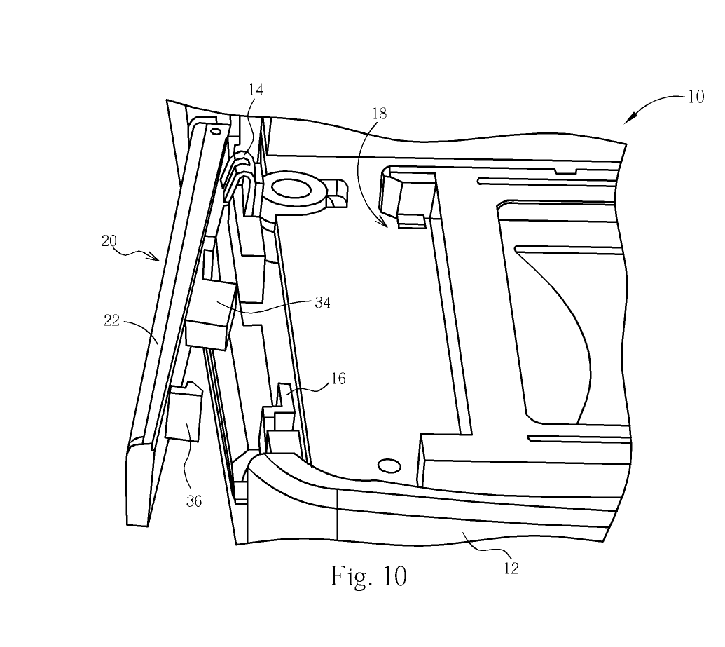

Please refer to FIGS. 9 and 10, which are diagrams of opening the cover 20. In FIGS. 9 and 10, there is no memory card 15 inside the cavity 18. When the user presses the second end of the activating element 30, the activating element 30 rotates to make the hook 36 separate from the slot 16, as shown in FIG. 9. After that, the second flexible element 14 immediately provides a bounce to the cover 20 to rotate it outward, as shown in FIG. 10.

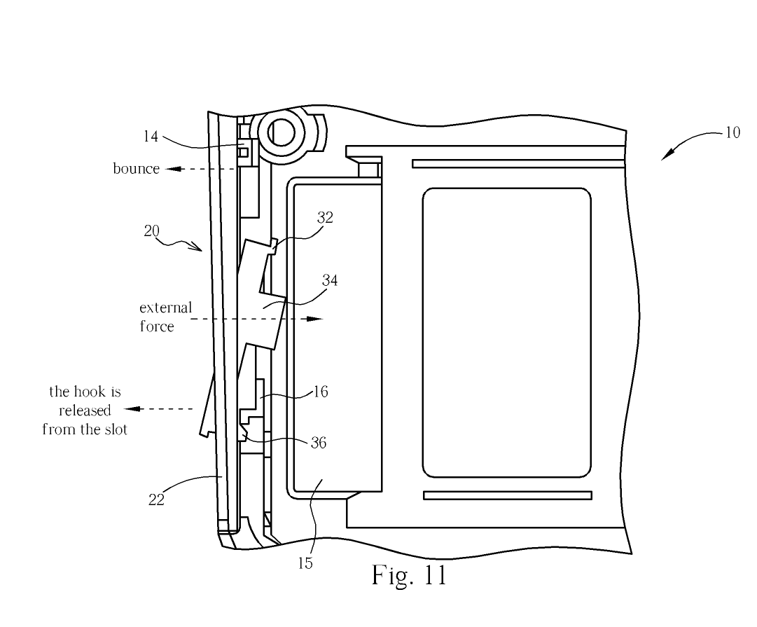

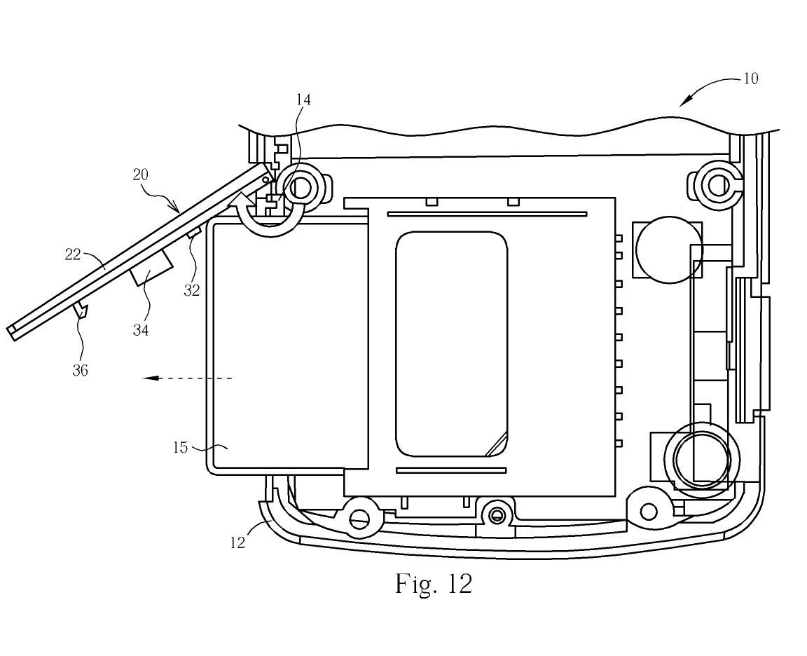

FIGS. 11 and 12 are diagrams showing taking the memory card 15 out. When removing the memory card 15 from the cavity 18, the user presses the second end of the activating element 30. The protrusion 34 pushes the memory card 15, and then the flexible piece 11 is pressed. The bounce of the flexible piece 11 ejects the memory card 15 from the cavity 18. Each force is shown in FIG. 11. The user provides an external force on the second end of the activating element 20, such that the hook 36 separates from the slot 16. The second flexible element 14 provides a bounce to the cover 20. The cover 20 is pushed outward, and then the memory card 15 is ejected, as shown in FIG. 12.

The above is a complete description of the first embodiment of the present invention. The key point of the present invention is to use the activating element 30 to push the memory card 15, so that the memory card 15 is ejected by the bounce effect of the first flexible element. The activating element 30 of another embodiment of the present invention does not comprise the protrusion 34, but still accomplishes the same effect.

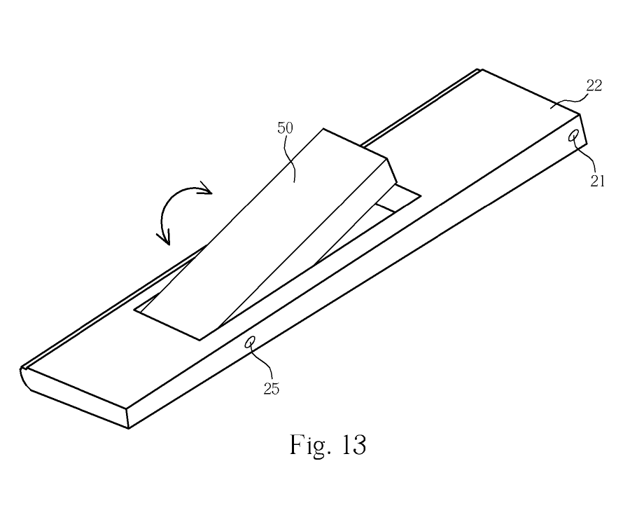

For instance, if there is no protrusion 34, an end of the stopper 32 is used for pushing the memory card 15, which can still eject the memory card 15 when the cover 20 is opened. Please refer to FIG. 13, which is another embodiment of the activating element 50 of the present invention. The structure of the activating element 50 does not include the protrusion 34, the stopper 32 and the hook 36. In this case, an end of the activating element 50 is rotatably connected to an end of the opening 24 via the revolving spindle 25. The user just pushes the other end of the activating element 50 to eject the memory card 15.

Additionally, the cover 20 of the present invention can be implemented in an electronic device, such as a mobile phone, a digital camera, a notebook computer, or a personal data assistant (PDA).

Compared with the prior art, the present invention ejects the memory card while the cover is opened, so that the user can take out the memory card by pressing the cover instead of directly pushing the memory card inside the memory slot. In addition, the present invention utilizes the cover to protect the memory card. The cover will also not be deformed after frequently being used.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An electronic device comprising: a body having a cavity for accommodating a card; a first flexible element positioned at an end of the cavity for pushing the card;
and a cover rotatably connected to the body via a first end of the cover, the cover comprising:
a panel having an opening; and
an activating element rotatably positioned inside the opening.

2. The electronic device of claim 1 further comprising a slot positioned on the body, the activating element of the cover comprising a hook for engaging the slot after a first end of the activating element is pressed.

3. The electronic device of claim 2 further comprising a second flexible element positioned on the body, wherein the second flexible element pushes the cover while the hook is released from the slot, so that a second end of the cover departs from the body.

4. The electronic device of claim 2 wherein the activating element further comprises a stopper for pressing against the panel to prevent the activating element from rotating further when the hook engages the slot.

5. The electronic device of claim 4 wherein the activating element comprises a protrusion for pushing the card when a second end of the activating element is pressed, so that the card presses the first flexible element.

6. The electronic device of claim 4 wherein an end of the stopper is for pushing the card.

7. The electronic device of claim 1 as a mobile phone, a digital camera, a notebook computer, or a personal data assistant (PDA).

8. The electronic device of claim 1 wherein the card is a secure digital (SD) card, a compact flash (CF) card, or a multimedia card (MMC).

9. The electronic device of claim 1 wherein the activating element comprises a protrusion for pushing the card when an end of the activating element is pressed, so that the card presses the first flexible element.

10. The electronic device of claim 1 wherein an end of the activating element is rotatably connected to an end of the panel adjacent to the opening.

11. The electronic device of claim 1 wherein an end of the activating element is for pushing the card.
